(19) United States
(12) Patent Application Publication
(10) Pub. No.: US 2019/0316849 A1
(43) Pub. Date: Oct. 17, 2019

(54) THERMAL MANAGEMENT, HEAT TRANSFER IMPROVEMENT OF RADIATOR AND CONDENSER USING AC SYSTEM EVAPORATOR'S CONDENSATION

(71) Applicant: NIO USA, Inc., San Jose, CA (US)

(72) Inventors: Armando Mendez Abrego, Sunnyvale, CA (US); Joshua Smith, Los Gatos, CA (US)

(21) Appl. No.: 15/950,768

(22) Filed: Apr. 11, 2018

(51) Int. Cl. F28D 15/06; F25B 39/04; F25B 39/02; F28F 27/00

(52) U.S. Cl. CPC F28D 15/06; F25B 39/04; H01M 10/625; F28F 27/00; F25B 39/02

(57) ABSTRACT

Embodiments of the present disclosure are directed to using condensation from an evaporator of a cooling system of the vehicle to facilitate thermal management of systems or components of the vehicle. According to one embodiment, a vehicle can comprise a cooling system evaporator and a condensation water collection system disposed in proximity to the cooling system evaporator. The condensation water collection system can be adapted to collect and accumulate condensed water from the cooling system evaporator. The vehicle can further comprise a heat exchange and one or more spray nozzles disposed proximate to the heat exchanger. The spray nozzles can be adapted to dispense a mist of water obtained from the water accumulated by the condensation water collection system onto the heat exchanger.

### FIELD

The present disclosure is generally directed to thermal management of vehicle systems, and in particular, toward using condensation from an evaporator of a cooling system of the vehicle to facilitate thermal management of systems or components of the vehicle.

### BACKGROUND

Traditional vehicle liquid-to-air heat exchangers such as the coolant radiator, air conditioning condenser, etc. transfer heat between the ambient air and a cooling fluid such as engine coolant, refrigerant, etc. by passing the ambient air over a heat exchanger's finned tubes through which the cooling medium flows. For example, engine coolant is circulated through the radiator by a pump and air is forced through the radiator while the vehicle is moving and/or drawn through the radiator by a fan when the vehicle is stationary or moving at low speeds. The heat transfer path from air to liquid goes via the heat exchanger itself, namely its fins and tubes, which serve to increase the surface area in order to enhance heat transfer. However, when such cooling is most important or in highest demand, the ambient air is typically higher making this exchange via the surface area of the heat exchanger less efficient. Hence, there is a need in the art for improved systems and methods for thermal management in a vehicle.

### BRIEF DESCRIPTION OF THE DRAWINGS

FIG. 1 shows a vehicle in accordance with embodiments of the present disclosure;

FIG. 2 shows a plan view of the vehicle in accordance with at least some embodiments of the present disclosure;

FIG. 3 shows a plan view of the vehicle in accordance with embodiments of the present disclosure;

FIG. 4 is a block diagram illustrating an exemplary thermal management system for a vehicle according to one embodiment of the present disclosure; and

FIG. 5 is a flowchart illustrating an exemplary method for thermal management of one or more systems or components of a vehicle according to one embodiment of the present disclosure.

### DETAILED DESCRIPTION

Embodiments of the present disclosure will be described in connection with a vehicle, and in some embodiments, an electric vehicle, rechargeable electric vehicle, and/or hybrid-electric vehicle and associated systems.

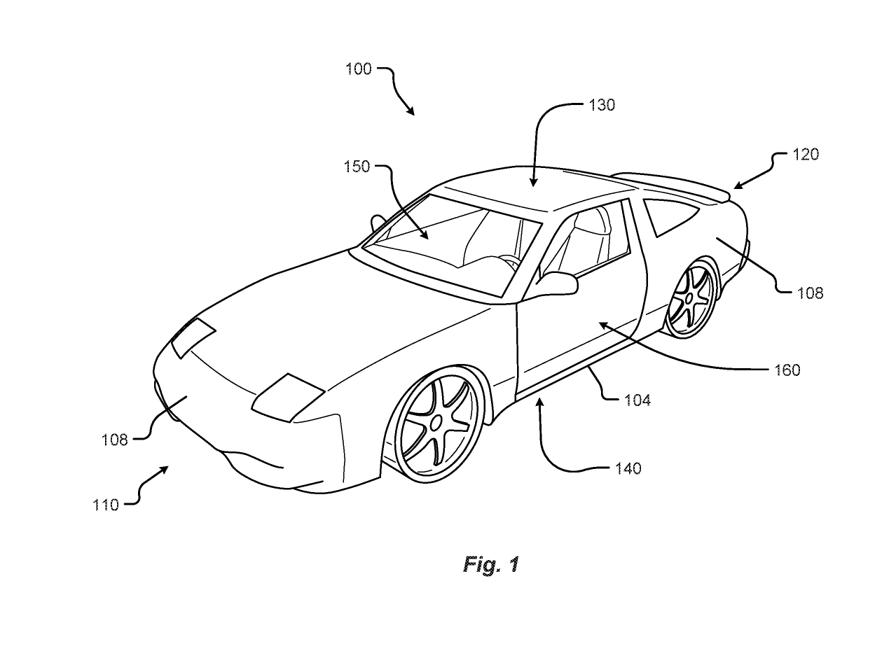

FIG. 1 shows a perspective view of a vehicle 100 in accordance with embodiments of the present disclosure. The electric vehicle 100 comprises a vehicle front 110, vehicle aft 120, vehicle roof 130, at least one vehicle side 160, a vehicle undercarriage 140, and a vehicle interior 150. In any event, the vehicle 100 may include a frame 104 and one or more body panels 108 mounted or affixed thereto. The vehicle 100 may include one or more interior components (e.g., components inside an interior space 150, or user space, of a vehicle 100, etc.), exterior components (e.g., components outside of the interior space 150, or user space, of a vehicle 100, etc.), drive systems, controls systems, structural components, etc.

Although shown in the form of a car, it should be appreciated that the vehicle 100 described herein may include any conveyance or model of a conveyance, where the conveyance was designed for the purpose of moving one or more tangible objects, such as people, animals, cargo, and the like. The term “vehicle” does not require that a conveyance moves or is capable of movement. Typical vehicles may include but are in no way limited to cars, trucks, motorcycles, busses, automobiles, trains, railed conveyances, boats, ships, marine conveyances, submarine conveyances, airplanes, space craft, flying machines, human-powered conveyances, and the like.

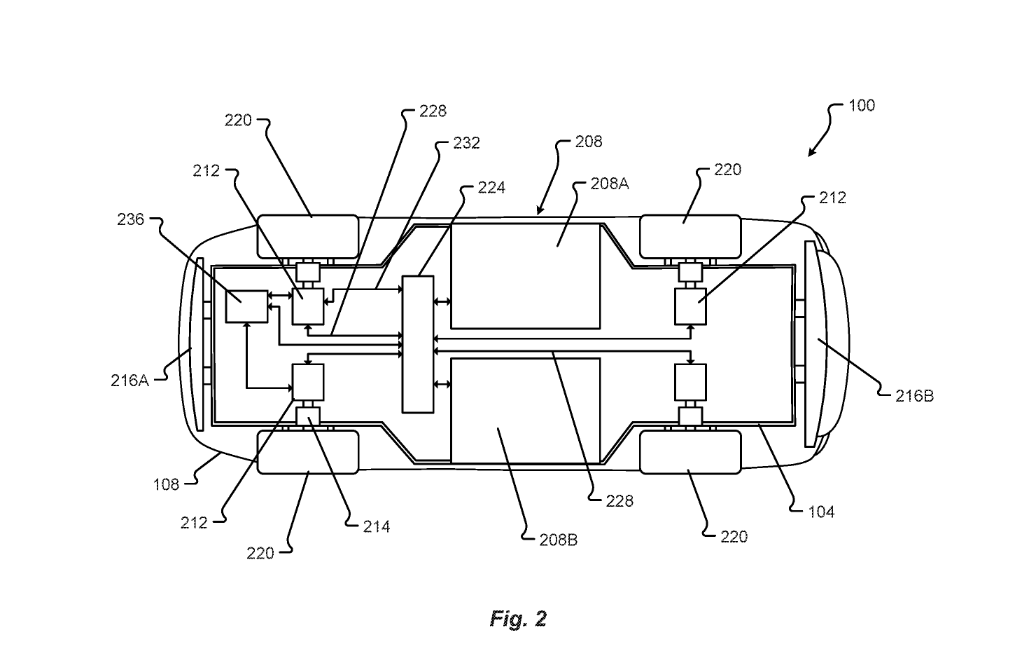

Referring now to FIG. 2, a plan view of a vehicle 100 will be described in accordance with embodiments of the present disclosure. As provided above, the vehicle 100 may comprise a number of electrical and/or mechanical systems, subsystems, etc. The mechanical systems of the vehicle 100 can include structural, power, safety, and communications subsystems, to name a few. While each subsystem may be described separately, it should be appreciated that the components of a particular subsystem may be shared between one or more other subsystems of the vehicle 100.

The structural subsystem includes the frame 104 of the vehicle 100. The frame 104 may comprise a separate frame and body construction (i.e., body-on-frame construction), a unitary frame and body construction (i.e., a unibody construction), or any other construction defining the structure of the vehicle 100. The frame 104 may be made from one or more materials including, but in no way limited to steel, titanium, aluminum, carbon fiber, plastic, polymers, etc., and/or combinations thereof. In some embodiments, the frame 104 may be formed, welded, fused, fastened, pressed, etc., combinations thereof, or otherwise shaped to define a physical structure and strength of the vehicle 100. In any event, the frame 104 may comprise one or more surfaces, connections, protrusions, cavities, mounting points, tabs, slots, or other features that are configured to receive other components that make up the vehicle 100. For example, the body panels 108, powertrain subsystem, controls systems, interior components, communications subsystem, and safety subsystem may interconnect with, or attach to, the frame 104 of the vehicle 100.

The frame 104 may include one or more modular system and/or subsystem connection mechanisms. These mechanisms may include features that are configured to provide a selectively interchangeable interface for one or more of the systems and/or subsystems described herein. The mechanisms may provide for a quick exchange, or swapping, of components while providing enhanced security and adaptability over conventional manufacturing or attachment. For instance, the ability to selectively interchange systems and/or subsystems in the vehicle 100 allow the vehicle 100 to adapt to the ever-changing technological demands of society and advances in safety. Among other things, the mechanisms may provide for the quick exchange of batteries, capacitors, power sources 208A, 208B, motors 212, engines, safety equipment, controllers, user interfaces, interiors exterior components, body panels 108, bumpers 216, sensors, etc., and/or combinations thereof. Additionally or alternatively, the mechanisms may provide unique security hardware and/or software embedded therein that, among other things, can prevent fraudulent or low quality construction replacements from being used in the vehicle 100. Similarly, the mechanisms, subsystems, and/or receiving features in the vehicle 100 may employ poka-yoke, or mistake-proofing, features that ensure a particular mechanism is always interconnected with the vehicle 100 in a correct position, function, etc.

By way of example, complete systems or subsystems may be removed and/or replaced from a vehicle 100 utilizing a single-minute exchange (“SME”) principle. In some embodiments, the frame 104 may include slides, receptacles, cavities, protrusions, and/or a number of other features that allow for quick exchange of system components. In one embodiment, the frame 104 may include tray or ledge features, mechanical interconnection features, locking mechanisms, retaining mechanisms, etc., and/or combinations thereof. In some embodiments, it may be beneficial to quickly remove a used power source 208A, 208B (e.g., battery unit, capacitor unit, etc.) from the vehicle 100 and replace the used power source 208A, 208B with a charged or new power source. Continuing this example, the power source 208A, 208B may include selectively interchangeable features that interconnect with the frame 104 or other portion of the vehicle 100. For instance, in a power source 208A, 208B replacement, the quick release features may be configured to release the power source 208A, 208B from an engaged position and slide or move in a direction away from the frame 104 of a vehicle 100. Once removed, or separated from, the vehicle, the power source 208A, 208B may be replaced (e.g., with a new power source, a charged power source, etc.) by engaging the replacement power source into a system receiving position adjacent to the vehicle 100. In some embodiments, the vehicle 100 may include one or more actuators configured to position, lift, slide, or otherwise engage the replacement power source with the vehicle 100. In one embodiment, the replacement power source may be inserted into the vehicle 100 or vehicle frame 104 with mechanisms and/or machines that are external and/or separate from the vehicle 100.

In some embodiments, the frame 104 may include one or more features configured to selectively interconnect with other vehicles and/or portions of vehicles. These selectively interconnecting features can allow for one or more vehicles to selectively couple together and decouple for a variety of purposes. For example, it is an aspect of the present disclosure that a number of vehicles may be selectively coupled together to share energy, increase power output, provide security, decrease power consumption, provide towing services, and/or provide a range of other benefits. Continuing this example, the vehicles may be coupled together based on travel route, destination, preferences, settings, sensor information, and/or some other data. The coupling may be initiated by at least one controller of the vehicle and/or traffic control system upon determining that a coupling is beneficial to one or more vehicles in a group of vehicles or a traffic system. As can be appreciated, the power consumption for a group of vehicles traveling in a same direction may be reduced or decreased by removing any aerodynamic separation between vehicles. In this case, the vehicles may be coupled together to subject only the foremost vehicle in the coupling to air and/or wind resistance during travel. In one embodiment, the power output by the group of vehicles may be proportionally or selectively controlled to provide a specific output from each of the one or more of the vehicles in the group.

The interconnecting, or coupling, features may be configured as electromagnetic mechanisms, mechanical couplings, electromechanical coupling mechanisms, etc., and/or combinations thereof. The features may be selectively deployed from a portion of the frame 104 and/or body of the vehicle 100. In some cases, the features may be built into the frame 104 and/or body of the vehicle 100. In any event, the features may deploy from an unexposed position to an exposed position or may be configured to selectively engage/disengage without requiring an exposure or deployment of the mechanism from the frame 104 and/or body of the vehicle 100. In some embodiments, the interconnecting features may be configured to interconnect one or more of power, communications, electrical energy, fuel, and/or the like. One or more of the power, mechanical, and/or communications connections between vehicles may be part of a single interconnection mechanism. In some embodiments, the interconnection mechanism may include multiple connection mechanisms. In any event, the single interconnection mechanism or the interconnection mechanism may employ the poka-yoke features as described above.

The power system of the vehicle 100 may include the powertrain, power distribution system, accessory power system, and/or any other components that store power, provide power, convert power, and/or distribute power to one or more portions of the vehicle 100. The powertrain may include the one or more electric motors 212 of the vehicle 100. The electric motors 212 are configured to convert electrical energy provided by a power source into mechanical energy. This mechanical energy may be in the form of a rotational or other output force that is configured to propel or otherwise provide a motive force for the vehicle 100.

In some embodiments, the vehicle 100 may include one or more drive wheels 220 that are driven by the one or more electric motors 212 and motor controllers 214. In some cases, the vehicle 100 may include an electric motor 212 configured to provide a driving force for each drive wheel 220. In other cases, a single electric motor 212 may be configured to share an output force between two or more drive wheels 220 via one or more power transmission components. It is an aspect of the present disclosure that the powertrain may include one or more power transmission components, motor controllers 214, and/or power controllers that can provide a controlled output of power to one or more of the drive wheels 220 of the vehicle 100. The power transmission components, power controllers, or motor controllers 214 may be controlled by at least one other vehicle controller or computer system as described herein.

As provided above, the powertrain of the vehicle 100 may include one or more power sources 208A, 208B. These one or more power sources 208A, 208B may be configured to provide drive power, system and/or subsystem power, accessory power, etc. While described herein as a single power source 208 for sake of clarity, embodiments of the present disclosure are not so limited. For example, it should be appreciated that independent, different, or separate power sources 208A, 208B may provide power to various systems of the vehicle 100. For instance, a drive power source may be configured to provide the power for the one or more electric motors 212 of the vehicle 100, while a system power source may be configured to provide the power for one or more other systems and/or subsystems of the vehicle 100. Other power sources may include an accessory power source, a backup power source, a critical system power source, and/or other separate power sources. Separating the power sources 208A, 208B in this manner may provide a number of benefits over conventional vehicle systems. For example, separating the power sources 208A, 208B allow one power source 208 to be removed and/or replaced independently without requiring that power be removed from all systems and/or subsystems of the vehicle 100 during a power source 208 removal/replacement. For instance, one or more of the accessories, communications, safety equipment, and/or backup power systems, etc., may be maintained even when a particular power source 208A, 208B is depleted, removed, or becomes otherwise inoperable.

In some embodiments, the drive power source may be separated into two or more cells, units, sources, and/or systems. By way of example, a vehicle 100 may include a first drive power source 208A and a second drive power source 208B. The first drive power source 208A may be operated independently from or in conjunction with the second drive power source 208B and vice versa. Continuing this example, the first drive power source 208A may be removed from a vehicle while a second drive power source 208B can be maintained in the vehicle 100 to provide drive power. This approach allows the vehicle 100 to significantly reduce weight (e.g., of the first drive power source 208A, etc.) and improve power consumption, even if only for a temporary period of time. In some cases, a vehicle 100 running low on power may automatically determine that pulling over to a rest area, emergency lane, and removing, or “dropping off,” at least one power source 208A, 208B may reduce enough weight of the vehicle 100 to allow the vehicle 100 to navigate to the closest power source replacement and/or charging area. In some embodiments, the removed, or “dropped off,” power source 208A may be collected by a collection service, vehicle mechanic, tow truck, or even another vehicle or individual.

The power source 208 may include a GPS or other geographical location system that may be configured to emit a location signal to one or more receiving entities. For instance, the signal may be broadcast or targeted to a specific receiving party. Additionally or alternatively, the power source 208 may include a unique identifier that may be used to associate the power source 208 with a particular vehicle 100 or vehicle user. This unique identifier may allow an efficient recovery of the power source 208 dropped off. In some embodiments, the unique identifier may provide information for the particular vehicle 100 or vehicle user to be billed or charged with a cost of recovery for the power source 208.

The power source 208 may include a charge controller 224 that may be configured to determine charge levels of the power source 208, control a rate at which charge is drawn from the power source 208, control a rate at which charge is added to the power source 208, and/or monitor a health of the power source 208 (e.g., one or more cells, portions, etc.). In some embodiments, the charge controller 224 or the power source 208 may include a communication interface. The communication interface can allow the charge controller 224 to report a state of the power source 208 to one or more other controllers of the vehicle 100 or even communicate with a communication device separate and/or apart from the vehicle 100. Additionally or alternatively, the communication interface may be configured to receive instructions (e.g., control instructions, charge instructions, communication instructions, etc.) from one or more other controllers or computers of the vehicle 100 or a communication device that is separate and/or apart from the vehicle 100.

The powertrain includes one or more power distribution systems configured to transmit power from the power source 208 to one or more electric motors 212 in the vehicle 100. The power distribution system may include electrical interconnections 228 in the form of cables, wires, traces, wireless power transmission systems, etc., and/or combinations thereof. It is an aspect of the present disclosure that the vehicle 100 include one or more redundant electrical interconnections 232 of the power distribution system. The redundant electrical interconnections 232 can allow power to be distributed to one or more systems and/or subsystems of the vehicle 100 even in the event of a failure of an electrical interconnection portion of the vehicle 100 (e.g., due to an accident, mishap, tampering, or other harm to a particular electrical interconnection, etc.). In some embodiments, a user of a vehicle 100 may be alerted via a user interface associated with the vehicle 100 that a redundant electrical interconnection 232 is being used and/or damage has occurred to a particular area of the vehicle electrical system. In any event, the one or more redundant electrical interconnections 232 may be configured along completely different routes than the electrical interconnections 228 and/or include different modes of failure than the electrical interconnections 228 to, among other things, prevent a total interruption power distribution in the event of a failure.

In some embodiments, the power distribution system may include an energy recovery system 236. This energy recovery system 236, or kinetic energy recovery system, may be configured to recover energy produced by the movement of a vehicle 100. The recovered energy may be stored as electrical and/or mechanical energy. For instance, as a vehicle 100 travels or moves, a certain amount of energy is required to accelerate, maintain a speed, stop, or slow the vehicle 100. In any event, a moving vehicle has a certain amount of kinetic energy. When brakes are applied in a typical moving vehicle, most of the kinetic energy of the vehicle is lost as the generation of heat in the braking mechanism. In an energy recovery system 236, when a vehicle 100 brakes, at least a portion of the kinetic energy is converted into electrical and/or mechanical energy for storage. Mechanical energy may be stored as mechanical movement (e.g., in a flywheel, etc.) and electrical energy may be stored in batteries, capacitors, and/or some other electrical storage system. In some embodiments, electrical energy recovered may be stored in the power source 208. For example, the recovered electrical energy may be used to charge the power source 208 of the vehicle 100.

The vehicle 100 may include one or more safety systems. Vehicle safety systems can include a variety of mechanical and/or electrical components including, but in no way limited to, low impact or energy-absorbing bumpers 216A, 216B, crumple zones, reinforced body panels, reinforced frame components, impact bars, power source containment zones, safety glass, seatbelts, supplemental restraint systems, air bags, escape hatches, removable access panels, impact sensors, accelerometers, vision systems, radar systems, etc., and/or the like. In some embodiments, the one or more of the safety components may include a safety sensor or group of safety sensors associated with the one or more of the safety components. For example, a crumple zone may include one or more strain gages, impact sensors, pressure transducers, etc. These sensors may be configured to detect or determine whether a portion of the vehicle 100 has been subjected to a particular force, deformation, or other impact. Once detected, the information collected by the sensors may be transmitted or sent to one or more of a controller of the vehicle 100 (e.g., a safety controller, vehicle controller, etc.) or a communication device associated with the vehicle 100 (e.g., across a communication network, etc.).

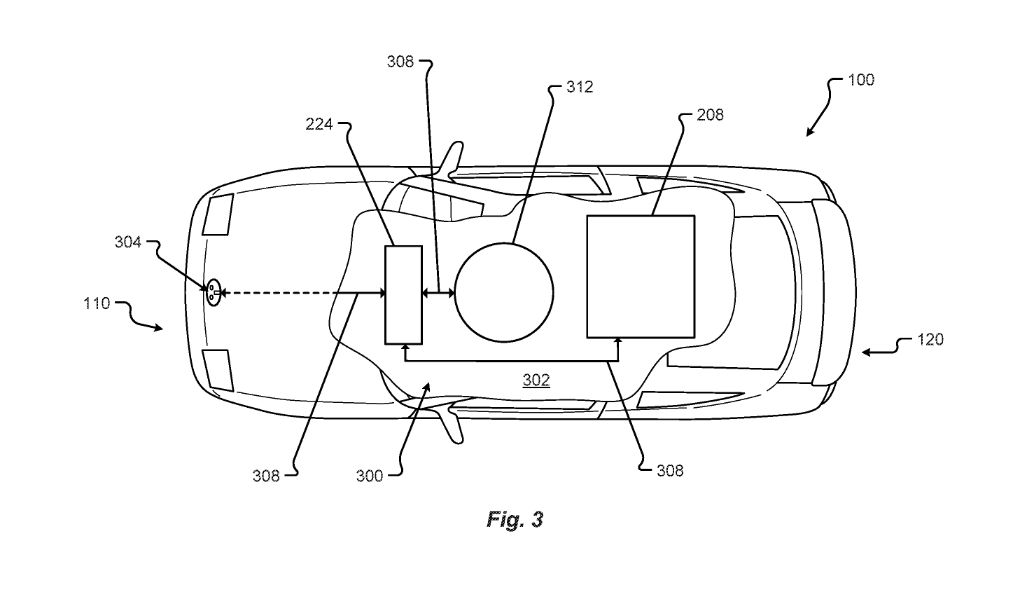

FIG. 3 shows a plan view of the vehicle 100 in accordance with embodiments of the present disclosure. In particular, FIG. 3 shows a broken section 302 of a charging system 300 for the vehicle 100. The charging system 300 may include a plug or receptacle 304 configured to receive power from an external power source (e.g., a source of power that is external to and/or separate from the vehicle 100, etc.). An example of an external power source may include the standard industrial, commercial, or residential power that is provided across power lines. Another example of an external power source may include a proprietary power system configured to provide power to the vehicle 100. In any event, power received at the plug/receptacle 304 may be transferred via at least one power transmission interconnection 308. Similar, if not identical, to the electrical interconnections 228 described above, the at least one power transmission interconnection 308 may be one or more cables, wires, traces, wireless power transmission systems, etc., and/or combinations thereof. Electrical energy in the form of charge can be transferred from the external power source to the charge controller 224. As provided above, the charge controller 224 may regulate the addition of charge to at least one power source 208 of the vehicle 100 (e.g., until the at least one power source 208 is full or at a capacity, etc.).

In some embodiments, the vehicle 100 may include an inductive charging system and inductive charger 312. The inductive charger 312 may be configured to receive electrical energy from an inductive power source external to the vehicle 100. In one embodiment, when the vehicle 100 and/or the inductive charger 312 is positioned over an inductive power source external to the vehicle 100, electrical energy can be transferred from the inductive power source to the vehicle 100. For example, the inductive charger 312 may receive the charge and transfer the charge via at least one power transmission interconnection 308 to the charge controller 324 and/or the power source 208 of the vehicle 100. The inductive charger 312 may be concealed in a portion of the vehicle 100 (e.g., at least partially protected by the frame 104, one or more body panels 108, a shroud, a shield, a protective cover, etc., and/or combinations thereof) and/or may be deployed from the vehicle 100. In some embodiments, the inductive charger 312 may be configured to receive charge only when the inductive charger 312 is deployed from the vehicle 100. In other embodiments, the inductive charger 312 may be configured to receive charge while concealed in the portion of the vehicle 100.

In addition to the mechanical components described herein, the vehicle 100 may include a number of user interface devices. The user interface devices receive and translate human input into a mechanical movement or electrical signal or stimulus. The human input may be one or more of motion (e.g., body movement, body part movement, in two-dimensional or three-dimensional space, etc.), voice, touch, and/or physical interaction with the components of the vehicle 100. In some embodiments, the human input may be configured to control one or more functions of the vehicle 100 and/or systems of the vehicle 100 described herein. User interfaces may include, but are in no way limited to, at least one graphical user interface of a display device, steering wheel or mechanism, transmission lever or button (e.g., including park, neutral, reverse, and/or drive positions, etc.), throttle control pedal or mechanism, brake control pedal or mechanism, power control switch, communications equipment, etc.

Typically, the vehicle 100 can include a cabin air conditioning (AC) system. As known in the art, the AC system can provide cabin or passenger compartment air at a comfortable temperature and humidity to the occupants. To do so, air is blown over a heat exchanger, i.e., the evaporator, containing a fluid at a temperature lower than the air temperature. As a result, moisture condenses on the evaporator, forming droplets that then fall down to a collection pan in the AC unit. In hot, humid climates, the amount of water collected in the air condition unit can exceed 1 gallon per day. The condensation must generally be removed to avoid the formation of mildew. Therefore, the moisture is usually expelled from the unit via a drain that allows the moisture to drip to the ground.

Embodiments of the present disclosure are directed to capturing and utilizing this condensed water. Generally speaking, embodiments described herein are directed to collecting this condensed water and dispensing it in the form of a fine mist or spray onto or into a heat exchanger of the vehicle such as the radiator or battery heat exchanger to assist with the thermal management of those components. By applying this mist or spray, the transfer or ability heat exchanger to dissipate heat into the environment can be improved. This approach can help to eliminate AC system water dripping under the cars as well as reduce the risk of condensation dripping near or onto high voltage components in the case of electric or hybrid vehicles. By improving the heat transfer capacity for a heat exchanger, energy savings can be realized. For example, use of these embodiments can result in less usage of a cooling fan which, on electric vehicle applications, results in battery energy savings.

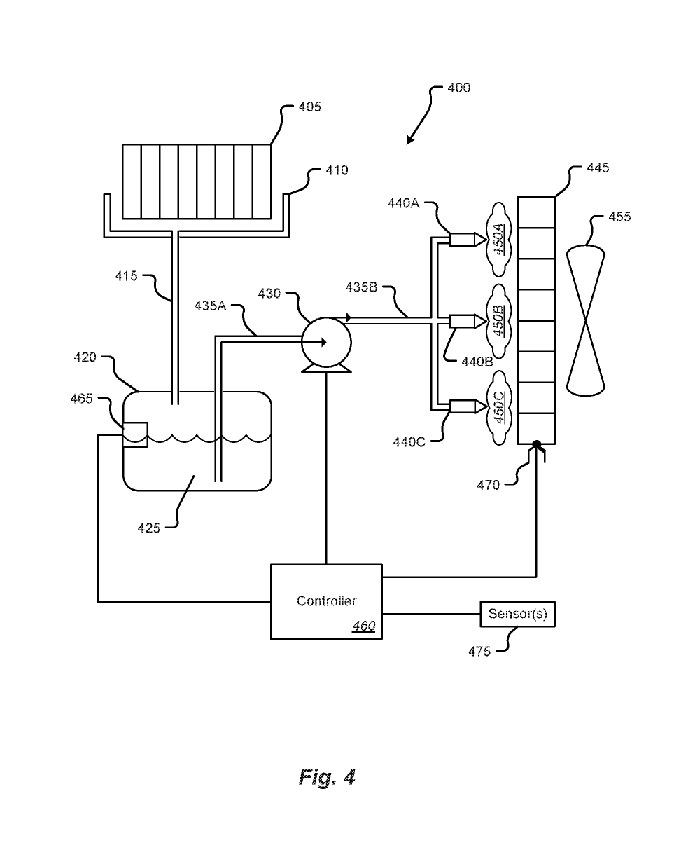

FIG. 4 is a block diagram illustrating an exemplary thermal management system for a vehicle according to one embodiment of the present disclosure. As illustrated in this example, a vehicle 100 such as described above can comprise a thermal management system 400. The vehicle 100 can also comprise a cooling system evaporator 405. The cooling system evaporator 405 can comprise, for example, an evaporator of a cabin air conditioning system of the vehicle 100. In other cases, the evaporator 405 may comprise an element of a cargo refrigeration system or other temperature or climate control system. As noted above, such an evaporator 405, especially when operated in hot, humid conditions, will produce a significant amount of condensation on the surfaces of the tubing and fins. Embodiments of the present disclosure are directed to capturing this condensation and utilizing it to assist with thermal management of other components of the vehicle 100.

Accordingly, the thermal management system 400 can further comprise a condensation water collection system disposed in proximity to the cooling system evaporator 405 and adapted to collect and accumulate condensed water from the cooling system evaporator 405. More specifically, the condensation water collection system can comprise a collection pan 410 disposed beneath the cooling system evaporator 405. The collection pan 410 can be positioned near the evaporator 405 and can be adapted to collect the condensed water from the cooling system evaporator 405 as it accumulates and runs and/or drips from the surfaces of the evaporator 405. A drain line 415, e.g., metal, vinyl, or other type of tubing, can be coupled with the collection pan 410. The drain line 415 can be coupled with the collection pan 410 via a hole and/or fitting in the pan 410 and can be adapted to allow the collected condensed water to drain from the collection pan 410. A reservoir 420 can also be coupled with the drain line 415 and can be adapted to receive and accumulate the collected condensed water 425 from the collection pan 410.

The vehicle 100 can further comprise one or more heat exchangers 445. As known in the art, the heat exchanger can comprise, for example, a radiator of an engine cooling system of the vehicle 100. In another example, such as in an electric or hybrid vehicle 100, the heat exchangers 445 can additionally or alternatively comprise a heat exchanger of a cooling system of a battery or battery charger of the vehicle 100. In yet another example, the heat exchanger 445 can comprise a condenser of the cabin air conditioning system of the vehicle 100. The heat exchanger 445 can comprise a set of tubing through which air or a fluid, such as engine coolant, is circulated and fins extending from the tubing to provide additional surface area for affect heat exchange from the air or fluid circulating through the tubing to the surrounding environment. In other cases, the heat exchanger 445 can comprise a heat sink coupled with another component to conduct heat away from that component and comprising a set of fins to increase the surface area of the heat sink. In either case, and as known in the art, a fan 455 may be disposed near the heat exchanger 445 which, when operated, can draw or force air through the heat exchanger 445 and over the tubing and/or fins therein to facilitate cooling of the heat exchanger 445.

According to one embodiment, cooling of the heat exchanger 445, and thus thermal management of the system or component in or on which the heat exchanger 445 operates, can be facilitated using the accumulated condensed water 425 in the reservoir 420. Accordingly, the thermal management system 400 of the vehicle 100 can further comprise a condensed water dispensing system. More specifically, the condensed water dispensing system can comprise a pump 430 and plumbing 435A and 435B connecting the reservoir 420 to the pump 430 and the pump 430 to one or more spray nozzles 440A-440C. The pump 430 can be adapted to pump the accumulated condensed water 425 from the reservoir 420, through the plumbing 435A and 435B, to the one or more spray nozzles 440A-440C. The one or more spray nozzles 440A-440C can be disposed proximate to the heat exchanger and can be adapted to dispense or discharge a mist 450A-450C or stream of the water pumped from the reservoir 420 onto the heat exchanger 445 and thereby provide additional cooling capacity, i.e., through the evaporative cooling effect of the water on the tubing and/or fins of the heat exchanger 445.

The thermal management system 400 can further comprise a controller 460 or control module. The controller 460 can comprise a processor and a memory having a set of instructions stored therein which, when executed by the processor, causes the controller to operate the pump 430 to pump the accumulated condensed water 425 from the reservoir 420, through the plumbing 435A and 435B, to the one or more spray nozzles 440a-440B.

The thermal management system 400 can further comprise a level sensor 465 communicatively coupled with the controller 460 and disposed in or on the reservoir 420. The level sensor 465 can comprise a float-type sensor or any of a variety of other suitable sensors as known in the art including but not limited to ultrasonic, infrared, etc., and can be adapted to detect an amount of the accumulated condensed water 425 in the reservoir 420. The instructions executed by the processor of the controller 460 can cause the controller 460 to operate the pump 430 based at least in part on the detected amount of the accumulated condensed water 425 in the reservoir 420. That is, the controller 460 can turned on and operate the pump 430 when the level sensor 465 indicates an amount of water in the reservoir 420 reaching a predetermined level, indicating a sufficient amount of available water. Conversely, the controller 460 can turned off or inhibit operation of the pump 430 when the level sensor 465 indicates an amount of water in the reservoir 420 at or below a predetermined level which would be an insufficient amount of available water.

The thermal management system 400 can further comprise a temperature sensor 470 communicatively coupled with the controller 460. The temperature sensor 470 can be positioned on or near the heat exchanger 445 and can be adapted to detect a temperature of the heat exchanger 445. The instructions executed by the processor of the controller 460 can cause the controller 460 to operate the pump 430 based at least in part on the detected temperature. For example, the controller 460 can turn on the pump 430 to discharge water from the nozzles 440A-440C when the temperature of the heat exchanger 445 indicated by the temperature sensor 470 meets or exceeds a predetermine temperature and turn the pump 430 off when the temperature of the heat exchanger 445 falls to or below this same or a different predetermined temperature.

According to one embodiment, the controller 460 can additionally or alternatively monitor one or more other sensors 475 and/or systems of the vehicle 100. These sensors and/or systems can include, but are not limited to, other temperature sensors on other systems or components of the vehicle 100, e.g., engine, transmission, invertors, drive motors, etc., a throttle or throttle body position sensor, drive motor or other drive system load sensors, e.g., watt meter, ammeter, etc. The controller 460 can additionally or alternatively receive input from systems of the vehicle including, but not limited to, a motor controller, a navigation system, one or more autonomous driving systems, etc. Based on the input(s) from these sensor(s) 475 and/or systems of the vehicle 100, the controller to monitor one or more conditions or expected conditions of the vehicle while the vehicle is operating and generate one or more predictions of heating based on the monitoring of the one or more conditions or expected conditions. For example, based on an increased speed, engine or motor load, etc., heating at the radiator, batteries, drive motors, etc. can be predicted. In another example, a prediction of increased load and increased heating can be made based on navigation and/or autonomous driving system input indicating that the vehicle 100 is or will soon be driving up a steep hill. In yet another example, based on input from or by monitoring a navigation system, an autonomous driving system, and/or a battery management system, a prediction can be made that the batteries will soon be placed on charge or subject to a rapid discharge. In any of these or other cases, in response to and/or based on these predictions, the controller 460 can preemptively operate the pump 430 to begin applying additional cooling even before heating has begun.

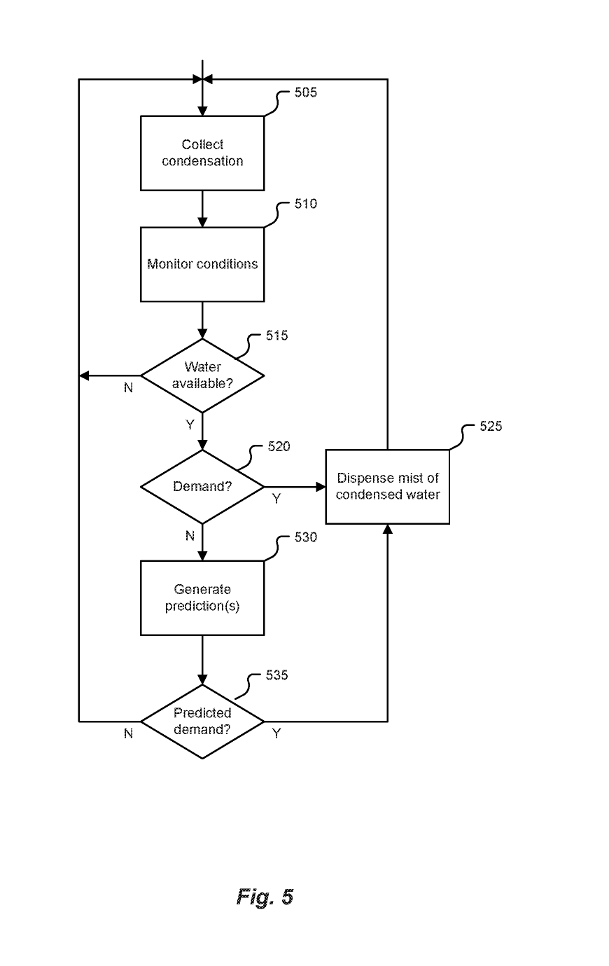

FIG. 5 is a flowchart illustrating an exemplary method for thermal management of one or more systems or components of a vehicle according to one embodiment of the present disclosure. As illustrated in this example, thermal management of one or more systems or components of a vehicle 100 can comprise collecting 505, by a thermal management system 400 of the vehicle 100, condensation water from an evaporator 405 of a cooling system of the vehicle 100 such as described above. The thermal management system 400 can monitor 510 an amount of condensation water collected from the evaporator 405 and one or more conditions of the vehicle 100 during operation of the vehicle. For example, and as described above, the amount of condensation water collected can be monitored 510 through a level sensor 465 in the reservoir 420 of the thermal management system 400. As also described above, monitoring 510 one or more conditions can comprise, for example, monitoring a temperature of the heat exchanger 445 through a temperature sensor 470 or monitoring other conditions of the vehicle 100 through one or more other sensors 475 and/or systems.

Based on this monitoring, one or more determinations 515 and 520 can be made. For example, a determination 515 can be made as to whether the amount of collected water is sufficient, e.g., has reached a certain level in the reservoir 420. If sufficient collected condensation water is available, a further determination 520 can be made as to whether there is a demand for additional cooling, e.g., based on the monitored temperature of the heat exchanger 445 or other conditions. Based on the amount of condensation water collected from the evaporator and the one or more conditions of the vehicle, a mist of water from the collected condensation water can be dispensed 525 onto the heat exchanger 445 of the vehicle 100.

Optionally, and according to one embodiment, even if a determination 520 is made that there is not a current demand for additional cooling based on monitoring 510 current conditions of the vehicle 100, one or more predictions of heating of the heat exchanger 445 can be generated 530 based at least in part on the monitoring of the one or more conditions of the vehicle 100 as described in detail above. Based on the generated 530 one or more predictions, a determination 535 can be made and the mist of water can be dispensed 525 onto the heat exchanger preemptively to address the expected or predicted heating conditions.

Any of the steps, functions, and operations discussed herein can be performed continuously and automatically.

The exemplary systems and methods of this disclosure have been described in relation to vehicle systems and electric vehicles. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices, such as a server, communication device, or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

While the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

Embodiments include a vehicle comprising a cooling system evaporator, a condensation water collection system disposed in proximity to the cooling system evaporator and adapted to collect and accumulate condensed water from the cooling system evaporator, a heat exchange, and one or more spray nozzles disposed proximate to the heat exchanger and adapted to dispense a mist of water onto the heat exchanger, the mist of water obtained from the water accumulated by the condensation water collection system.

Aspects of the above vehicle include wherein the cooling system evaporator comprises an evaporator of a cabin air conditioning system of the vehicle.

Aspects of the above vehicle include wherein the heat exchanger comprises a radiator of an engine cooling system of the vehicle.

Aspects of the above vehicle include wherein the heat exchanger comprises a heat exchanger of a cooling system of a battery or battery charger of the vehicle.

Aspects of the above vehicle include wherein the heat exchanger comprises a condenser of a cabin air conditioning system of the vehicle.

Aspects of the above vehicle include wherein the condensation water collection system further comprises a collection pan disposed beneath the cooling system evaporator and adapted to collect the condensed water from the cooling system evaporator, a drain line coupled with the collection pan and adapted to allow the collected condensed water to drain from the collection pan, a reservoir coupled with the drain line and adapted to receive and accumulate the collected condensed water from the collection pan, a pump, and plumbing connecting the reservoir to the pump and the pump to the one or more spray nozzles, wherein the pump is adapted to pump the accumulated condensed water from the reservoir, through the plumbing, to the one or more spray nozzles.

Aspects of the above vehicle further include a controller, the controller comprising a processor and a memory having a set of instructions stored therein which, when executed by the processor, causes the controller to operate the pump to pump the accumulated condensed water from the reservoir, through the plumbing, to the one or more spray nozzles.

Aspects of the above vehicle include wherein the collection system further comprises a level sensor of the reservoir communicatively coupled with the controller and adapted to detect an amount of the accumulated condensed water in the reservoir and wherein the instructions further cause the processor to operate the pump based at least in part on the detected amount of the accumulated condensed water.

Aspects of the above vehicle include wherein the collection system further comprises a temperature sensor of the heat exchanger communicatively coupled with the controller and adapted to detect a temperature of the heat exchanger and wherein the instructions further cause the processor to operate the pump based at least in part on the detected temperature.

Aspects of the above vehicle include wherein the instructions further cause the controller to monitor one or more conditions or expected conditions of the vehicle while the vehicle is operating, generate one or more predictions of heating of the heat exchanger based on the monitoring of the one or more conditions or expected conditions, and operate the pump based on the generated one or more predictions.

Embodiments include a thermal management system for a vehicle, the thermal management system comprising a condensation water collection system adapted to collect and accumulate condensed water from an evaporator of a cooling system of the vehicle and a condensed water dispensing system comprising one or more spray nozzles adapted to dispense a mist of water onto a heat exchanger of the vehicle, the mist of water obtained from the water accumulated by the condensation water collection system.

Aspects of the above thermal management system include wherein the condensation water collection system further comprises a collection pan disposed beneath the cooling system evaporator and adapted to collect the condensed water from the cooling system evaporator, a drain line coupled with the collection pan and adapted to allow the collected condensed water to drain from the collection pan, and a reservoir coupled with the drain line and adapted to receive and accumulate the collected condensed water from the collection pan.

Aspects of the above thermal management system include wherein the condensed water dispensing system further comprises a pump and plumbing connecting the reservoir of the condensation water collection system to the pump and the pump to the one or more spray nozzles, wherein the pump is adapted to pump the accumulated condensed water from the reservoir, through the plumbing, to the one or more spray nozzles.

Aspects of the above thermal management system further include a controller, the controller comprising a processor and a memory having a set of instructions stored therein which, when executed by the processor, causes the controller to operate the pump to pump the accumulated condensed water from the reservoir, through the plumbing, to the one or more spray nozzles.

Aspects of the above thermal management system include wherein the collection system further comprises a level sensor of the reservoir communicatively coupled with the controller and adapted to detect an amount of the accumulated condensed water in the reservoir and wherein the instructions further cause the processor to operate the pump based at least in part on the detected amount of the accumulated condensed water.

Aspects of the above thermal management system include wherein the condensed water dispensing system further comprises a temperature sensor of the heat exchanger communicatively coupled with the controller and adapted to detect a temperature of the heat exchanger and wherein the instructions further cause the processor to operate the pump based at least in part on the detected temperature.

Aspects of the above thermal management system include wherein the instructions further cause the controller to monitor one or more conditions or expected conditions of the vehicle while the vehicle is operating, generate one or more predictions of heating of the heat exchanger based on the monitoring of the one or more conditions or expected conditions, and operate the pump based on the generated one or more predictions.

Embodiments include a method for thermal management of one or more systems or components of a vehicle, the method comprising collecting, by a thermal management system of a vehicle, condensation water from an evaporator of a cooling system of the vehicle, monitoring, by the thermal management system, an amount of condensation water collected from the evaporator and one or more conditions of the vehicle during operation of the vehicle, and dispensing, by the thermal management system, a mist of water from the collected condensation water onto a heat exchanger of the vehicle based on the amount of condensation water collected from the evaporator and the one or more conditions of the vehicle.

Aspects of the above method include wherein monitoring comprises monitoring a temperature of the heat exchanger and where dispensing the mist of water onto the heat exchanger comprises dispensing the mist of water based on the monitored temperature of the heat exchanger.

Aspects of the above method further include generating one or more predictions of heating of the heat exchanger based at least in part on the monitoring of the one or more conditions of the vehicle and wherein dispensing the mist of water onto the heat exchanger is further based on the generated one or more predictions.

Any one or more of the aspects/embodiments as substantially disclosed herein.

Any one or more of the aspects/embodiments as substantially disclosed herein optionally in combination with any one or more other aspects/embodiments as substantially disclosed herein.

One or means adapted to perform any one or more of the above aspects/embodiments as substantially disclosed herein.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “electric vehicle” (EV), also referred to herein as an electric drive vehicle, may use one or more electric motors or traction motors for propulsion. An electric vehicle may be powered through a collector system by electricity from off-vehicle sources or may be self-contained with a battery or generator to convert fuel to electricity. An electric vehicle generally includes a rechargeable electricity storage system (RESS) (also called Full Electric Vehicles (FEV)). Power storage methods may include: chemical energy stored on the vehicle in on-board batteries (e.g., battery electric vehicle or BEV), on board kinetic energy storage (e.g., flywheels), and/or static energy (e.g., by on-board double-layer capacitors). Batteries, electric double-layer capacitors, and flywheel energy storage may be forms of rechargeable on-board electrical storage.

The term “hybrid electric vehicle” refers to a vehicle that may combine a conventional (usually fossil fuel-powered) powertrain with some form of electric propulsion. Most hybrid electric vehicles combine a conventional internal combustion engine (ICE) propulsion system with an electric propulsion system (hybrid vehicle drivetrain). In parallel hybrids, the ICE and the electric motor are both connected to the mechanical transmission and can simultaneously transmit power to drive the wheels, usually through a conventional transmission. In series hybrids, only the electric motor drives the drivetrain, and a smaller ICE works as a generator to power the electric motor or to recharge the batteries. Power-split hybrids combine series and parallel characteristics. A full hybrid, sometimes also called a strong hybrid, is a vehicle that can run on just the engine, just the batteries, or a combination of both. A mid hybrid is a vehicle that cannot be driven solely on its electric motor, because the electric motor does not have enough power to propel the vehicle on its own.

The term “rechargeable electric vehicle” or “REV” refers to a vehicle with on board rechargeable energy storage, including electric vehicles and hybrid electric vehicles.

What is claimed is:

1. A vehicle, comprising:
a cooling system evaporator;
a condensation water collection system disposed in proximity to the cooling system evaporator and adapted to collect and accumulate condensed water from the cooling system evaporator;
a heat exchange; and
one or more spray nozzles disposed proximate to the heat exchanger and adapted to dispense a mist of water onto the heat exchanger, the mist of water obtained from the water accumulated by the condensation water collection system.

2. The vehicle of claim 1, wherein the cooling system evaporator comprises an evaporator of a cabin air conditioning system of the vehicle.

3. The vehicle of claim 1, wherein the heat exchanger comprises a radiator of an engine cooling system of the vehicle.

4. The vehicle of claim 1, wherein the heat exchanger comprises a heat exchanger of a cooling system of a battery or battery charger of the vehicle.

5. The vehicle of claim 1, wherein the heat exchanger comprises a condenser of a cabin air conditioning system of the vehicle.

6. The vehicle of claim 1, wherein the condensation water collection system further comprises a collection pan disposed beneath the cooling system evaporator and adapted to collect the condensed water from the cooling system evaporator, a drain line coupled with the collection pan and adapted to allow the collected condensed water to drain from the collection pan, a reservoir coupled with the drain line and adapted to receive and accumulate the collected condensed water from the collection pan, a pump, and plumbing connecting the reservoir to the pump and the pump to the one or more spray nozzles, wherein the pump is adapted to pump the accumulated condensed water from the reservoir, through the plumbing, to the one or more spray nozzles.

7. The vehicle of claim 6, further comprising a controller, the controller comprising a processor and a memory having a set of instructions stored therein which, when executed by the processor, causes the controller to operate the pump to pump the accumulated condensed water from the reservoir, through the plumbing, to the one or more spray nozzles.

8. The vehicle of claim 7, wherein the collection system further comprises a level sensor of the reservoir communicatively coupled with the controller and adapted to detect an amount of the accumulated condensed water in the reservoir and wherein the instructions further cause the processor to operate the pump based at least in part on the detected amount of the accumulated condensed water.

9. The vehicle of claim 7, wherein the collection system further comprises a temperature sensor of the heat exchanger communicatively coupled with the controller and adapted to detect a temperature of the heat exchanger and wherein the instructions further cause the processor to operate the pump based at least in part on the detected temperature.

10. The vehicle of claim 7, wherein the instructions further cause the controller to monitor one or more conditions or expected conditions of the vehicle while the vehicle is operating, generate one or more predictions of heating of the heat exchanger based on the monitoring of the one or more conditions or expected conditions, and operate the pump based on the generated one or more predictions.

11. A thermal management system for a vehicle, the thermal management system comprising:
a condensation water collection system adapted to collect and accumulate condensed water from an evaporator of a cooling system of the vehicle; and
a condensed water dispensing system comprising one or more spray nozzles adapted to dispense a mist of water onto a heat exchanger of the vehicle, the mist of water obtained from the water accumulated by the condensation water collection system.

12. The thermal management system of claim 11, wherein the condensation water collection system further comprises a collection pan disposed beneath the cooling system evaporator and adapted to collect the condensed water from the cooling system evaporator, a drain line coupled with the collection pan and adapted to allow the collected condensed water to drain from the collection pan, and a reservoir coupled with the drain line and adapted to receive and accumulate the collected condensed water from the collection pan.

13. The thermal management system of claim 12, wherein the condensed water dispensing system further comprises a pump and plumbing connecting the reservoir of the condensation water collection system to the pump and the pump to the one or more spray nozzles, wherein the pump is adapted to pump the accumulated condensed water from the reservoir, through the plumbing, to the one or more spray nozzles.

14. The thermal management system of claim 13, further comprising a controller, the controller comprising a processor and a memory having a set of instructions stored therein which, when executed by the processor, causes the controller to operate the pump to pump the accumulated condensed water from the reservoir, through the plumbing, to the one or more spray nozzles.

15. The thermal management system of claim 14, wherein the collection system further comprises a level sensor of the reservoir communicatively coupled with the controller and adapted to detect an amount of the accumulated condensed water in the reservoir and wherein the instructions further cause the processor to operate the pump based at least in part on the detected amount of the accumulated condensed water.

16. The thermal management system of claim 14, wherein the condensed water dispensing system further comprises a temperature sensor of the heat exchanger communicatively coupled with the controller and adapted to detect a temperature of the heat exchanger and wherein the instructions further cause the processor to operate the pump based at least in part on the detected temperature.

17. The thermal management system of claim 14, wherein the instructions further cause the controller to monitor one or more conditions or expected conditions of the vehicle while the vehicle is operating, generate one or more predictions of heating of the heat exchanger based on the monitoring of the one or more conditions or expected conditions, and operate the pump based on the generated one or more predictions.

18. A method for thermal management of one or more systems or components of a vehicle, the method comprising:
collecting, by a thermal management system of a vehicle, condensation water from an evaporator of a cooling system of the vehicle;
monitoring, by the thermal management system, an amount of condensation water collected from the evaporator and one or more conditions of the vehicle during operation of the vehicle; and
dispensing, by the thermal management system, a mist of water from the collected condensation water onto a heat exchanger of the vehicle based on the amount of condensation water collected from the evaporator and the one or more conditions of the vehicle.

19. The method of claim 18, wherein monitoring comprises monitoring a temperature of the heat exchanger and wherein dispensing the mist of water onto the heat exchanger comprises dispensing the mist of water based on the monitored temperature of the heat exchanger.

20. The method of claim 18, further comprising generating one or more predictions of heating of the heat exchanger based at least in part on the monitoring of the one or more conditions of the vehicle and wherein dispensing the mist of water onto the heat exchanger is further based on the generated one or more predictions.
